(19) United States
(12) Patent Application Publication
(10) Pub. No.: US 2008/0114613 A1
(43) Pub. Date: May 15, 2008

(54) Integrated Electronic Healthcare Management System

(76) Inventors: Judith VanKirk-Smith, Eden Prairie, MN (US); Michael Cameron, Minneapolis, MN (US); Mark Seeyle, Eden Prairie, MN (US); Kalyana Santhanam, Glendale, AZ (US); Robert Paluc, Goodyear, AZ (US); Cynthia Middaugh, Eden Prairie, MN (US); Peggy Edmonds, Brunswick, GA (US); Nancy Sewitch, Cheshire, CT (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/559,148

(22) Filed: Nov. 13, 2006

(51) Int. Cl. G06Q 50/00

(52) U.S. Cl. 705/2

(57) ABSTRACT

An integrated electronic medical records and health care management system includes a managing application for receiving and storing member data associated with at least one member of a health plan. A risk assessment application coupled to the managing application generates a level of care for the member based upon the member data. A member safety knowledge database stores medication interaction data, and a clinical protocols knowledge database stores treatment data relating to the treatment of a plurality of health-related conditions. The managing application generates a plan of care for the member based upon the member data and member's level of care, the medication interaction data, and the treatment data. The managing application also monitors implementation of the member's plan of care and updates the plan of care based upon the implementation of the member's plan of care. The managing application may further generate coverage data indicating whether costs associated with a health-related service selected for the member are covered by the member's health insurance policy. The system may also include remote access server for enabling communication between the managing application and one or more remote terminals to enable automatic updating of data stored in the managing application and data collected and stored by the remote terminals.

### FIELD OF THE INVENTION

The present invention generally relates to an integrated electronic healthcare management system that provides a dynamic and comprehensive source of medical records and other health-related information for a plurality of individuals and generates a customized plan of care for each individual by identifying problems, goals, and action items for the care providers and/or care managers for each individual.

### BACKGROUND OF THE INVENTION

Currently, there are systems that manage medical records for patients, which may be implemented in a hospital or other centralized healthcare facility. There are also home health management systems that provide information associated with home care of individuals within the system. Such systems provide users with only a limited or partial view of the overall health and healthcare of the individuals in the system. As a result, users of the system are not able to access all data relating to the health and care of the individuals and have limited ability to assess and treat the individuals.

Given this drawback of the existing systems, there is a need for a system that provides a comprehensive source of all health-related information about each individual in the system, regardless of the location and circumstances of the treatment, assessment, or service. Moreover, there is a need for a system that can use the comprehensive information about each individual to identify potential and existing health-related problems and generate information needed to address these problems.

### SUMMARY OF THE INVENTION

In view of the drawbacks of existing systems described above, the present invention provides a comprehensive, integrated electronic healthcare management system that provides a comprehensive source of all medical records and health-related information about each individual in the system, regardless of the location and circumstances of the treatment, assessment, or service. This comprehensive data is accessible by each care provider and care manager for each individual enrolled in the system (“members”). Moreover, the system uses the comprehensive information about each member to identify automatically potential and existing health-related problems and to generate automatically a customized plan of care for each member by identifying problems, goals, and action items for the care providers and/or care managers for each member.

The system enables caregivers, care coordinators, providers, and members to better understand the members' medical, behavioral and social needs and also facilitates the flow of information among these entities. The system offers integrated tracking and monitoring of each member's health in order to enhance the overall member care process. The system may identify an enrollee's care level and determine an appropriate care management approach. The system also may enable proactive coordination of the care service needs for members at various risk levels.

The system may be implemented to operate remotely, for example, in members' homes or nursing facilities, and/or may be implemented to operate in a centralized local environment such as a hospital. In either implementation, the system provides connectivity to a clinical data storage facility to enable reporting functionality. Remote users may synchronize their systems with a central system to insure that they have the most current information available to them at their remote locations and to provide any updated information to the central system and other users that may need the updated information.

An integrated electronic medical records and health care management system may include a managing application for receiving and storing member data associated with at least one member of a health plan, a risk assessment application coupled to the managing application for generating a level of care for the member based upon the member data received by the management application, a member safety knowledge database for storing medication interaction data, and a clinical protocols knowledge database for storing treatment data relating to the treatment of a plurality of health-related conditions. The managing application may generate a plan of care (“plan of care”) for the member based upon the member data and member's level of care, the medication interaction data, and the treatment data; monitor implementation of the member's plan of care; and update the plan of care based upon the implementation of the member's plan of care. Each member's plan of care may include one or more diagnoses, medications, allergies, medication-to-medication interactions, medication-to-diagnoses interactions, medication-to-allergen interactions, problems, goals, and interventions for the member.

The managing application additionally may generate coverage data indicating whether costs associated with a health-related service selected for the member are covered by the member's health insurance policy.

The system may also include a member monitoring application for providing member monitoring data to the managing application, a reporting application for generating reports concerning healthcare management and implementation for members within a health plan, a demand management application for providing 24-hour member access to medical personnel, and/or a member education application for providing member access to health-related educational information.

The system also may include a remote access server for enabling communication between the managing application and one or more remote terminals, wherein, upon connection of the remote terminal to the remote access server, each remote terminal automatically receives from the managing application updated member data and member plans of care based upon an access level of a user of the remote terminal, and each remote terminal automatically transmits to the managing application updated data collected for any member.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 provides a diagram of an integrated electronic medical records and health care management system.

FIG. 2 provides an exemplary electronic display of a list of members assigned to a selected user of the system of FIG. 1.

FIG. 2A provides an exemplary electronic display of a list of tasks assigned to a selected user of the system of FIG. 1.

FIG. 2B provides an exemplary electronic display of a new task data entry screen for use in the system of FIG. 1.

FIG. 3 provides an exemplary electronic display of member data for a selected member in the system of FIG. 1.

FIG. 3A provides an exemplary electronic display of demographics data for a selected member in the system of FIG. 1.

FIG. 3B provides an exemplary electronic display of assignments data for a selected member in the system of FIG. 1.

FIGS. 4A-4G provide exemplary electronic displays enabling a user to create an inpatient notification for a member in the system of FIG. 1.

FIGS. 5A-4E provide exemplary electronic displays enabling a user to create an outpatient notification for a member in the system of FIG. 1.

FIG. 6 provides an exemplary electronic display of an assessment questionnaire for use by a user to obtain assessment information from a member in the system of FIG. 1.

FIG. 7 provides an exemplary electronic display of a customized healthcare management plan for a selected member in the system of FIG. 1.

FIGS. 8-8A provide exemplary electronic displays of diagnosis data and diagnosis data entry for a selected member in the system of FIG. 1.

FIGS. 9-9D provide exemplary electronic displays of medication data, medication data entry, medication-to-medication interaction data, medication-to-diagnosis interaction, and medication-to-allergen interaction data for a selected member in the system of FIG. 1.

FIGS. 10-10A provide exemplary electronic displays of allergy data and allergy data entry for a selected member in the system of FIG. 1.

FIGS. 11-11C provide exemplary electronic displays of problems, goals, and interventions data and data entry for a selected member in the system of FIG. 1.

FIGS. 12-12A provide exemplary electronic display of existing notes and new note entry for a selected member in the system of FIG. 1.

FIGS. 13-14D provide exemplary electronic displays of reporting functionality of the system of FIG. 1.

### DETAILED DESCRIPTION

An integrated electronic medical records and health care management system will now be described in detail with reference to the accompanying drawings.

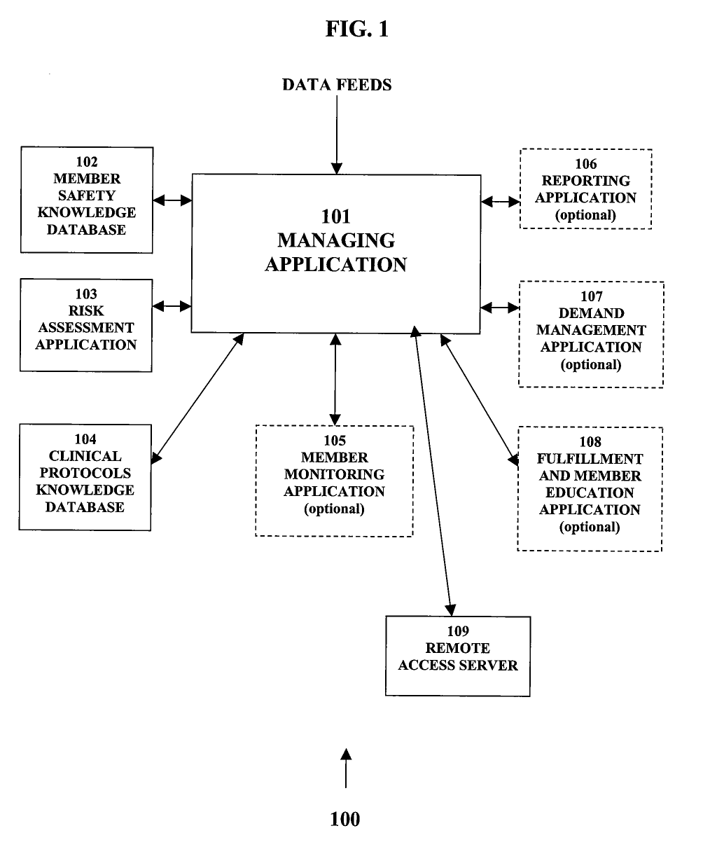

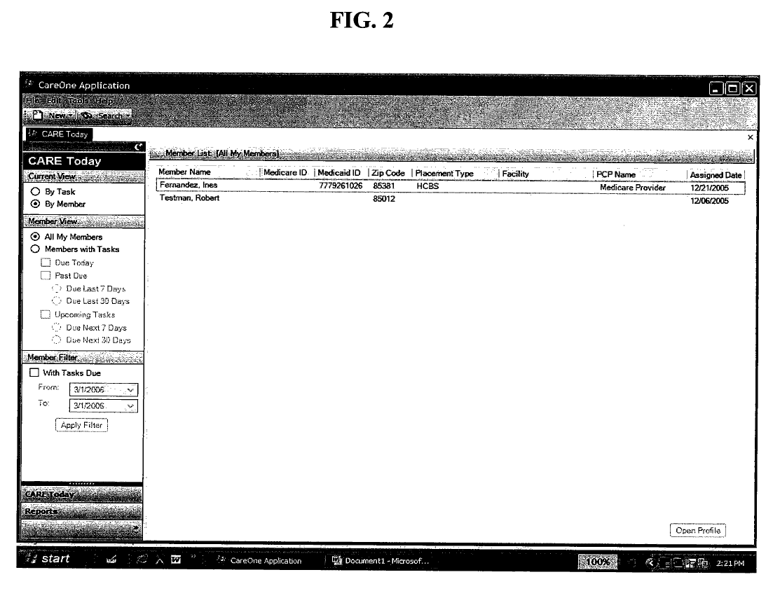

With reference to FIG. 1, an integrated electronic medical records and health care management system may be implemented to include a managing application 101 that interfaces with a member safety knowledge database 102, a risk assessment application 103, a clinical protocols knowledge database 104, an optional member monitoring application 105, an optional reporting application 106, an optional demand management nurse line 107, an optional member education application 108, and a remote access server 109. Each of these components may be implemented as components of a centralized system or as distributed network components that communicate with other components. The system 100 may be implemented using any desired combination of hardware and software components as desired by the implementers of the system 100. Moreover, portions of the system 100 functionality may be performed by one entity or by a number of entities, such as a combination of a central server that receives data feeds from one or more outside vendors that provide data and/or data analysis and/or processing services that are integrated to implement the functionality of the system 100. The functionality of system 100 is described in detail below.

In system 100, managing application 101 stores data concerning the members enrolled in the system as well as data concerning the users of the system. System users may include administrative users, care providers, care coordinators, and others who need access to the system for various reasons. Each user of the system is assigned an access level that determines the information that each user is able to access in the system. For example, an administrative user may be given full access to all information in the system, while a care coordinator or care provider may more limited access, for example, having access only to information on members enrolled in the coordinator's or provider's geographic area, or only to the members for which the coordinator or provider is responsible. The access level assigned for each user may also be used to determine the information exchanged between the system and a remote access system used by a coordinator, provider or other entity at a remote location, such as a member's home or care facility. Additional security may also be provided, for example, in the form of login password protection, encryption, or other security protocols.

User data may be entered by an administrator, by data feed, or by any other desired method. User data and properties may include identification and contact information, role assignment data (e.g, whether the user is a care provider, care coordinator, administrator, or other type of user), security and/or data access level assignment, assignment information, and other types of data as desired by the system implementers.

Member data includes all data used by the system 100 to generate a customized healthcare management plan (“plan of care”) and associated information for each member whose health care is managed by the system 100. Member data may be entered into the system, for example, by data feed, such as a feed created from a stream of medical and pharmaceutical claim data and assessment data for each member. Manual data entry or other methods of providing the data needed to perform the functions of the system may also be used as desired by the implementers and/or administrators of the system 100. Member data and properties loaded into the system 100 may include member medical records, medical and drug insurance claims, assessment data (for example, provided by the member upon enrollment into the system 100), laboratory reports, physical attributes, diagnoses, procedures, treatments, and conditions (including acute and chronic), home care information, healthcare provider information (e.g., primary care physician and any secondary care physicians, specialists or other healthcare providers used by the member), contact information, health insurance information, responsible party information, and any other information as desired by the implementers of the system.

In addition to member data and user data, managing application 101 also receives risk assessment data, such as a risk score, from risk assessment application 103; clinical information, such as evidence based medical protocols, from clinical protocols knowledge database 104; patient monitoring data such as calls made by users to monitor member status and digital biometric readings provided by members from optional member monitoring application 105; drug interaction, allergy interaction, and other patient safety data from knowledge database 102; and (optionally) educational information for the members from optional member education application 108. Using these inputs, managing application 101 generates a plan of care for each member and manages the implementation of the plan of care by the system 100 users assigned to each member. In addition, the managing application 101 enables users to perform notifications by which a clinician triggers a benefit coverage determination based upon the member's insurance coverage. Services and treatments covered by the member's insurance plans are determined to be fully covered (also referred to as “authorized”), partially covered, not covered (“denied”), or requiring further assessment, for example, by a supervisor (“pending”).

Managing application 101 also generates cost data for each member's treatments and services; provides customized medication interaction information, allergy information, and other safety information for each member based upon data from the member safety knowledge database 102; provides access to educational information for the members using optional member education application 108; and (optionally) may enable access to 24-hour medical support for the members via optional demand management application 107. Optional reporting application 106 provides various clinical and business reporting options as desired by the users and system implementers.

Operation of the system 100 will now be described in further detail.

When a new member is enrolled in the system, the managing application 101 requests and downloads all available member data for the new member. Managing application also provides the member data to risk assessment application 103, which generates a risk assessment of the new member, such as numerical risk score, rating, category or any other desired risk assessment. The risk assessment may be based, for example, on the number or cost of the member's previous medical claims, the nature of the member's diagnoses and treatments, the physical attributes of the member, etc.

In one example, the risk assessment application 103 is implemented using an external source, such as Hierarchical Condition Categories (HCCs), which are scores assigned, for example, by Centers for Medicare and Medicaid Services or Geriatric Health Systems, LLC, that calculate risk scores based upon medical claim data as well as information obtained from the new member in response to a questionnaire and provide the risk scores in the form of a data feed to the managing application 101. In other implementations, the risk assessment application may be provided as an internal component of the system 100.

The managing application 101 uses the risk assessment from risk assessment application 103 to assign a care level for the new member. For example, the managing application 101 may assign Level 1 if the member represents a low risk (the member is basically healthy and physically able), Level 2 if the member represents a moderate risk (the member may be at risk for a more serious illness and may need increased care), and Level 3 if the member represents a high risk (the member needs regular face-to-face visits). Assessments for existing members may be periodically updated or re-evaluated based upon subsequently received member data to insure that each member is receiving an appropriate level of care.

In addition to performing an assessment, each new member may be assigned to one or more care providers and one or more care managers. Care providers are responsible for delivering various forms of care to the member, while care coordinators and responsible for monitoring the care of the member and ordering various products and services as needed to care for the member. The assignment of care providers and care coordinators to each member may be performed, for example, geographically, based upon the experience of the care provider or coordinator and the conditions of the member, or based upon any other criteria as desired by the system implementers.

Using all of the member data for the new member and the assigned care level, the managing application 101 generates a plan of care for the new member. The plan of care for each member may include the member's diagnoses; medications; and allergies. A user may enter, edit and/or delete diagnoses, medications, allergies and associated notes or other information into the plan of care for members (depending on the user's assigned access level). Additionally, in some implementations, the plan of care may further include problems, goals and interventions for the member. In these implementations, users may also add, edit and/or delete problems, goals, and interventions for the members.

In implementations in which problems, goals, and interventions are generated and displayed, managing application 101 identifies the diagnoses, treatment, assessment and other medical and health data from the member data and uses it to identify the member's health problems (e.g., chronic health conditions) and the associated goals and interventions that are recommended to improve the health of the member based upon information stored in the clinical protocols knowledge data base 104. Users may also enter new problems, goals, and/or interventions, edit existing ones, or close items that have already been addressed, solved, or completed. Plans of care also may be automatically or manually updated based upon subsequently received member data, including claim data, data entered by users indicating completion of interventions, etc. Managing application 101 may further monitor the status of existing problems, goals, and interventions for each member to insure that duplicates are not added either automatically based upon subsequently received member data or manually by users.

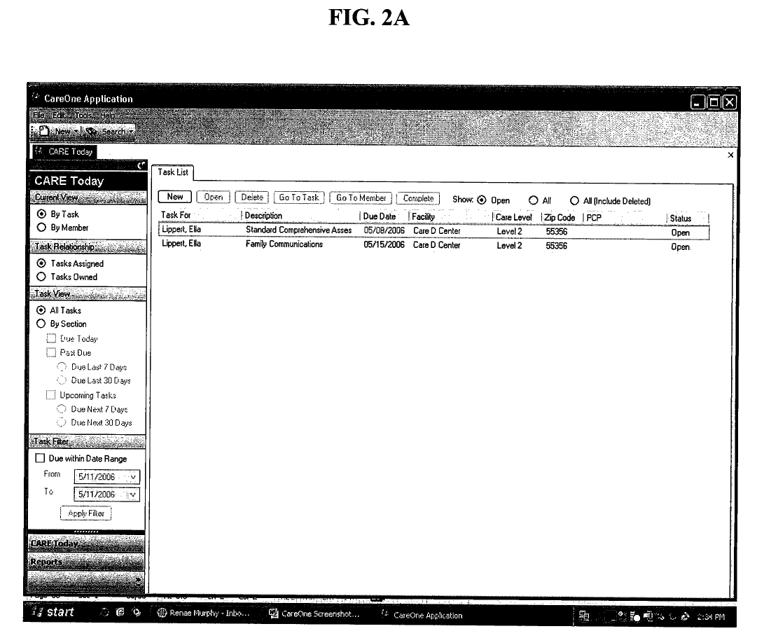

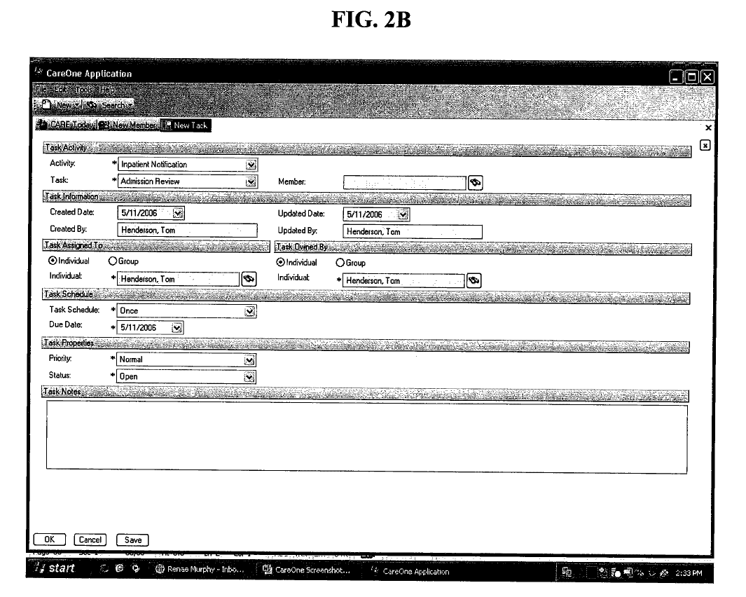

FIGS. 2-14 provide illustrations of exemplary user interfaces that enable users to implement the functionality of the system 100. The system 100 alternatively may be implemented in various other ways to provide the functionality described above.

The interfaces illustrated in FIGS. 2-14 provide an exemplary implementation of system 100 to provide integrated tracking and monitoring of members' health to enhance the overall member care process. The system 100 identifies an enrollee's care level and determines an appropriate and effective care management approach by creating a plan of care as described above. The system 100 further provides a means of proactively coordinating care service needs for members of various risk levels, e.g., high-risk members. The system 100 also enables improved information flow between payers, providers, caregiver, physicians, care coordinators, and members.

The system 100 may also be implemented to provide remote access capability to enable care providers and care coordinators to collect member information off-site, for example, at the member's home or care facility, for example, via remote access server 109. The care provider, care coordinator, or other system user may enter information into the system using an offline device running a stand-alone version of the system 100 software, such as a laptop computer or other portable electronic device at any location and later connect to the system to synchronize with the system 100, providing the remotely collected information to the system 100 while obtaining the latest updated information to be stored on the user's offline device.

In one implementation, remote users may sync their devices with the system 100 via a telephone line, VPN line or Internet connection with remote access server 109 coupled to managing application 101. Administrative data is maintained on the server at all times. Data is sent from the server down to the remote device, and data is sent from the remote device to the server 109. The synchronization process may run in the background such that the user need not initiate the sync process, but only access the server or network connection. The user may monitor or check the sync status at any time. When the sync process is interrupted, only data that was not transmitted prior to the interruption is transmitted during the next sync process. The application loaded on the remote device may be programmed to generate alert messages to the user to indicate that the sync process has not been performed for a defined period of time (such as 30 days). The system 100 may store sync statistics and information for each remote device with which it synchronizes data and may log error messages as needed.

Synchronization data may include HCPC/CPT service and procedure codes, ICD diagnosis codes, medication lists, allergies lists, provider data, configuration data, security data, maintenance data, region or health plan specific data, member demographics, member assignments, plan of care information, notifications, clinical care notes, tasks, and/or other data as desired by the system implementers.

The system 100 may automatically synchronize data to offline clients when they have connectivity. When the offline clients detect connectivity the system may automatically determine what data needs to be sent down to that particular client. These decisions may be made based on the user's identity who logs into the offline client, their member list, the tasks that they contain or receive, or workflow within the system. The system may automatically download dependent data. The synchronization process may also employ fuzzy logic to determine what data to send. For instance, if a nurse has a patient in a certain zip code, the system may automatically download all provider data in a twenty mile radius.

The system 100 further may allow the same security rights whether offline or online, so multiple users may modify the same data offline. When the synchronization process sends data changed offline, the system may automatically handle conflicts, alert users, and provide the ability to determine how to handle the conflict. The system may also automatically determine how to handle the conflict without user intervention.

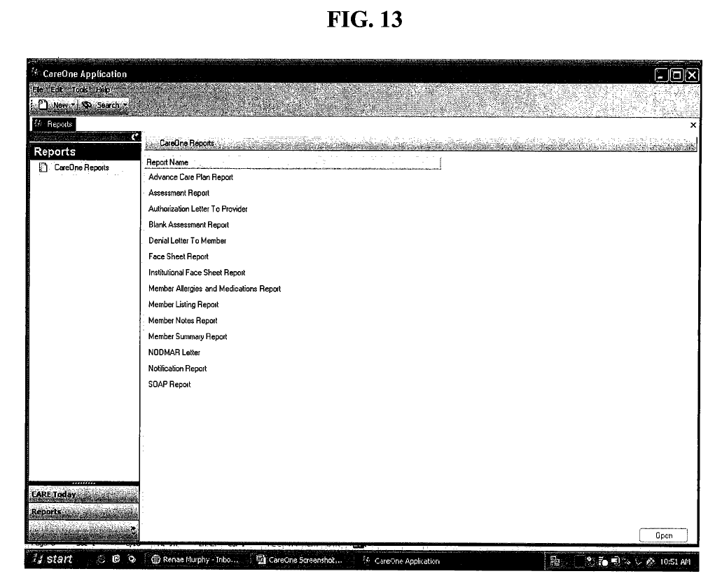

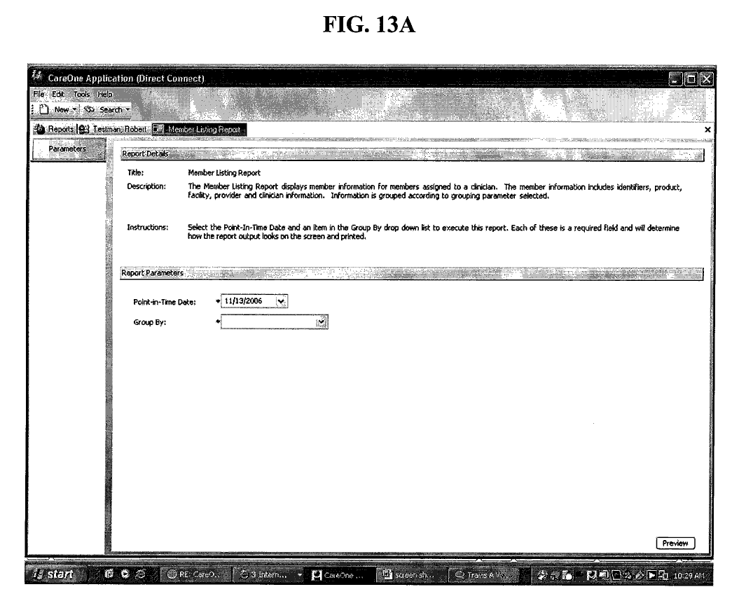

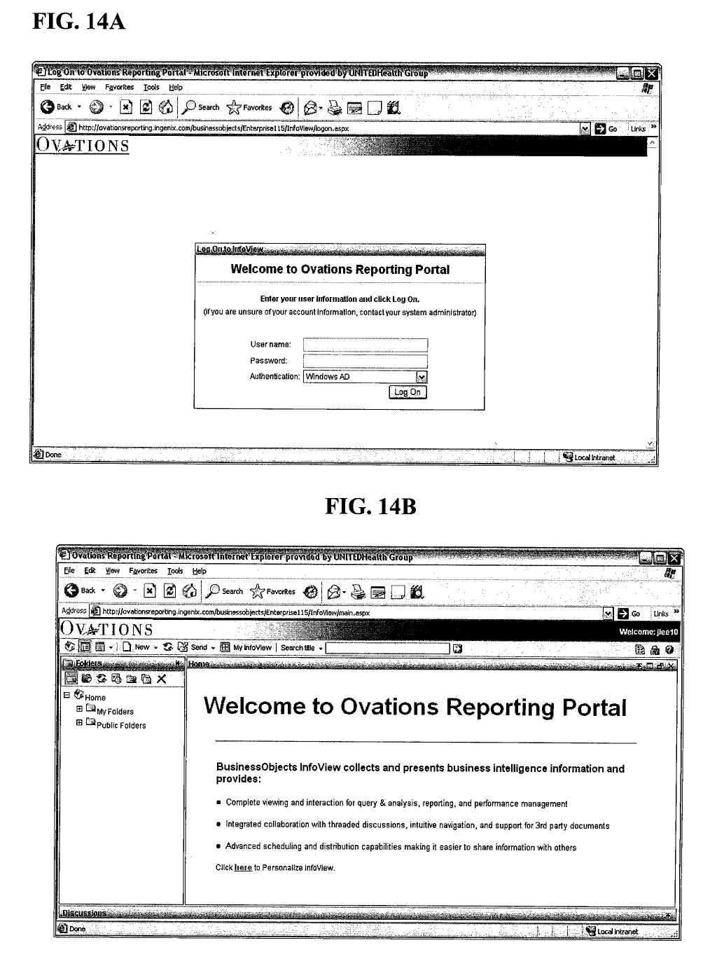

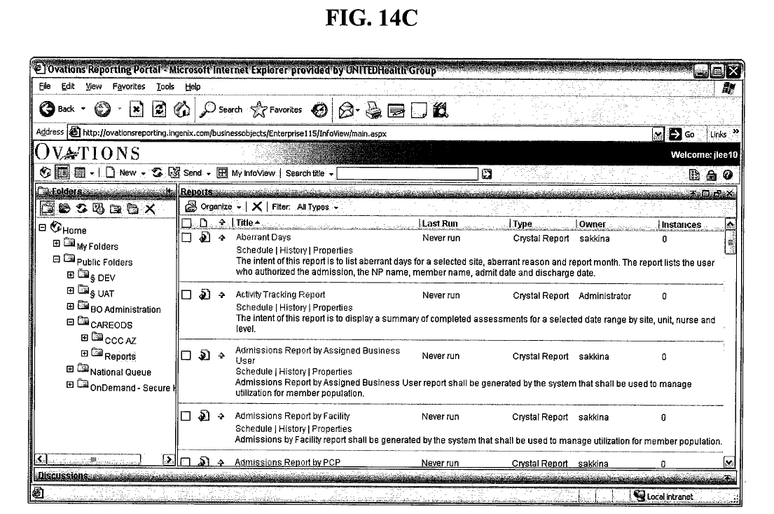

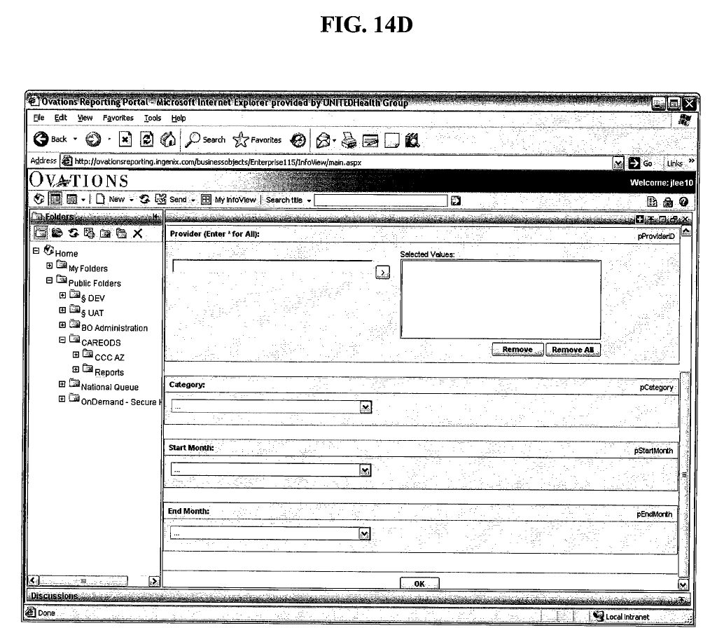

With reference to FIG. 2, upon logging in to the system 100, the system 100 displays to the user a list of the members to which the user is assigned for which the user has an assigned task on that day. The user has several display options, including Current View (including all items scheduled for the current date) displayed by task or by member; Member View including all members to which the user is assigned or only members with outstanding tasks; or Member Filter in which the user may select to display members with tasks due within a certain date range. A Report option is also provided, which will be discussed below in further detail with reference to FIGS. 13-14.

In FIG. 2, the “Current Display” selected is “By Member” and includes a member name, Medicare ID number, zip code, primary care physician (PCP) and assigned date for each displayed member.

The menu bar illustrated at the top of the display in FIG. 2 enables users to create and add new records, search for existing records, and edit records. The “File” menu may enable users to create various types of records or close the application. The “New” button also enables users to create new types of records, including the addition of new users (such as nurse practitioners, care managers, clinicians, supervisors, and/or managers), members, providers, or tasks. Member data, provider data and user data also or alternatively may be populated automatically by the managing application 101 of system 100. The “Edit” menu may enable users to cut, copy, and paste entries. The “Tools” menu may enable the user to search for various types of records or information (e.g., search for a business user, member, provider, service, or diagnosis) or to obtain system information such as the synchronization status of an offline device with the system 100. The “Search” button also enables the searching functionality.

FIG. 2A provides an illustration of a user's display when the user selects to view the “Current View” by task. Users are again given various display options, including display of tasks based upon the user's relationship to the task (whether the user is assigned to perform the task and/or is responsible for completion of—“owns”—the task), or based upon task view (by tasks or date). Tasks may also be sorted by priority level (normal, high, low, etc.).

TASKS: Tasks are scheduled appointments pertaining to a selected member. Each task represents something that a user must do for a member. Tasks may be generated automatically by the managing application 101 of system 100 and/or may be manually entered by a user. Tasks may be generated automatically when a new member enters the system (for example, when a new enrollee in a health plan) or based upon assessment or re-assessment responses. For example, when a new member is entered, system 100 may generate a care level based upon risk assessment data (described above with reference to risk assessment application 103) and assign a clinician (for example, based upon geographic location, level of care required for the member, and the clinician's case load). the system 100 may also automatically request a health risk assessment for the new member, which would appear as a task for the clinician assigned to the new member. Tasks also may be entered manually, for example, using the entry screen shown in FIG. 2B, by entering the activity and task required, task assignment information, and task scheduling and properties information.

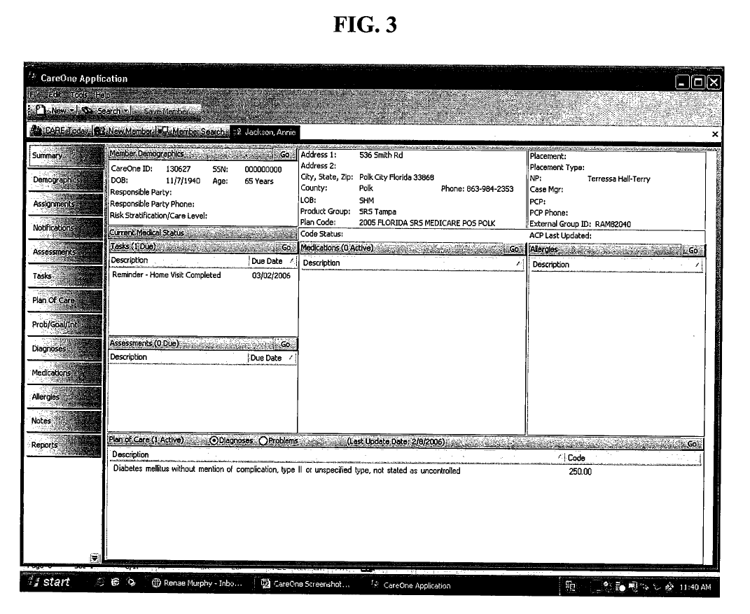

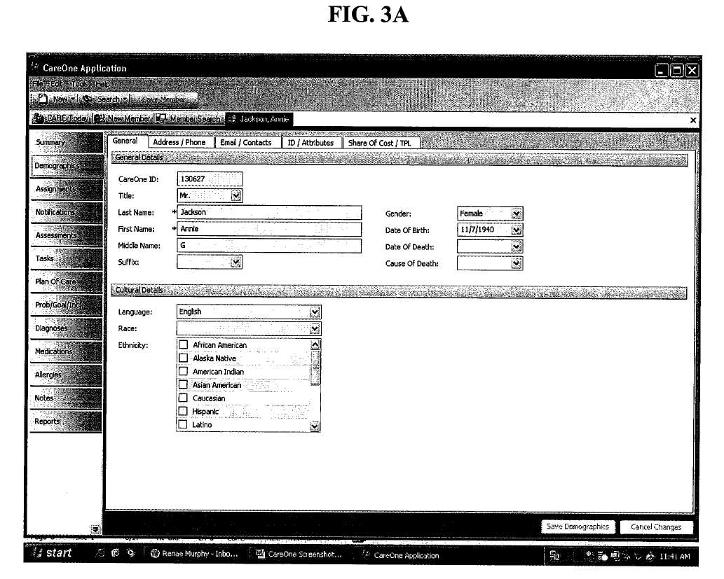

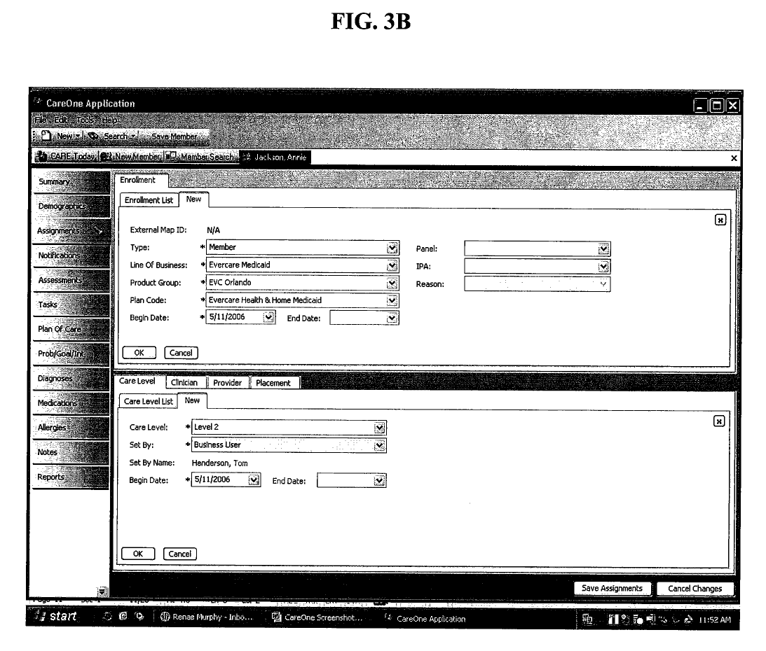

MEMBER SUMMARY: FIG. 3 provides an exemplary illustration of an information display for a selected member. The user may use the search functionality described above with reference to FIG. 2 to locate the record of a specific member. Upon selection of a member, the display in FIG. 3 is provided, including in the vertical menu a Summary of the member record, Demographics data, Assignments, Notifications, Assessments, Tasks, the member's Plan of Care, Problems/Goals/Interventions, Diagnoses, Medications, Allergies, Notes, and Reports.

The Summary of each member includes the member's demographic data, such as an identification number, date of birth, social security number, age, address, insurance information, etc. It also provides a summary of tasks and assessments due for the member, as well as a summary of the member's plan of care, including diagnoses, problems, goals, and interventions.

DEMOGRAPHICS: As shown in FIG. 3A, the Demographics menu selection in FIG. 3 enables the user to access and edit the user's demographic data, including general details, contact information, ID information, and insurance coverage information.

ASSIGNMENTS: With reference to FIG. 3B, the Assignments menu selection enables the user to view and manage the member's assignments. Assignments may be used to identify specific care levels (e.g., Levels 1-3), clinicians, providers and placements (the facility where the member resides) for the member. A member's care level and enrollment data (typically insurance plan enrollment data), provider and placement data may be manually entered or received from a data feed, for example, from the member's insurance company. The clinician assignment data may be automatically generated by the managing application 101.

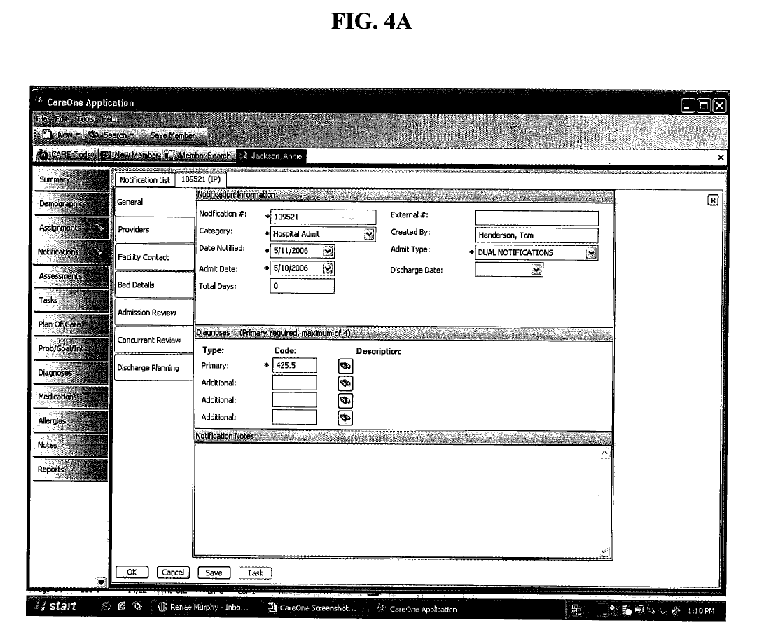

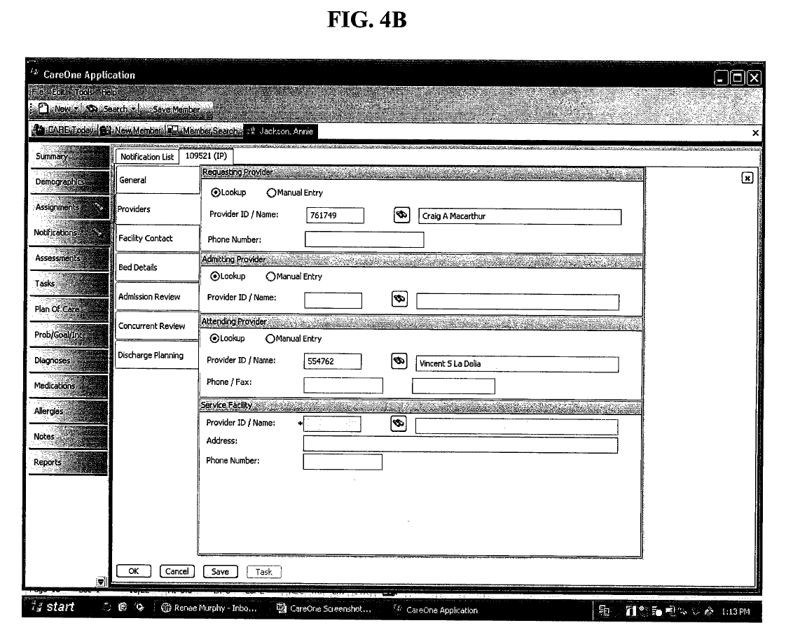

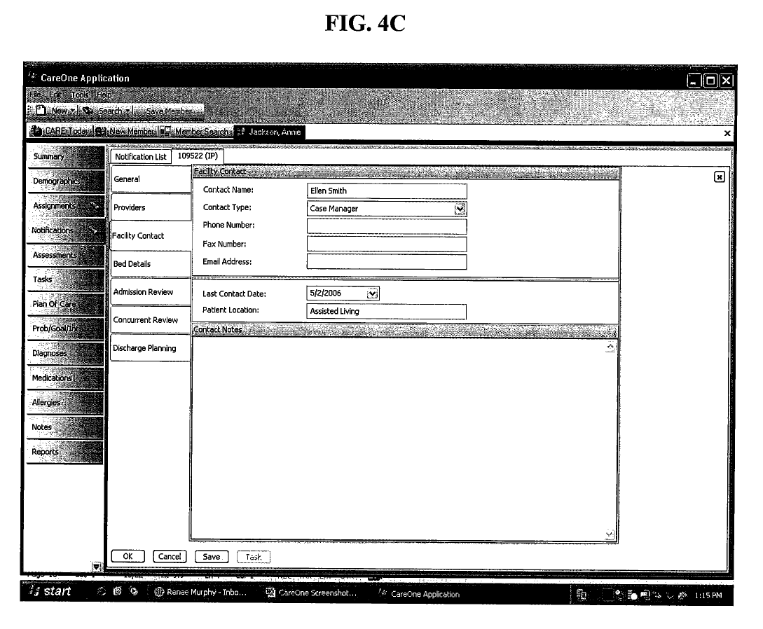

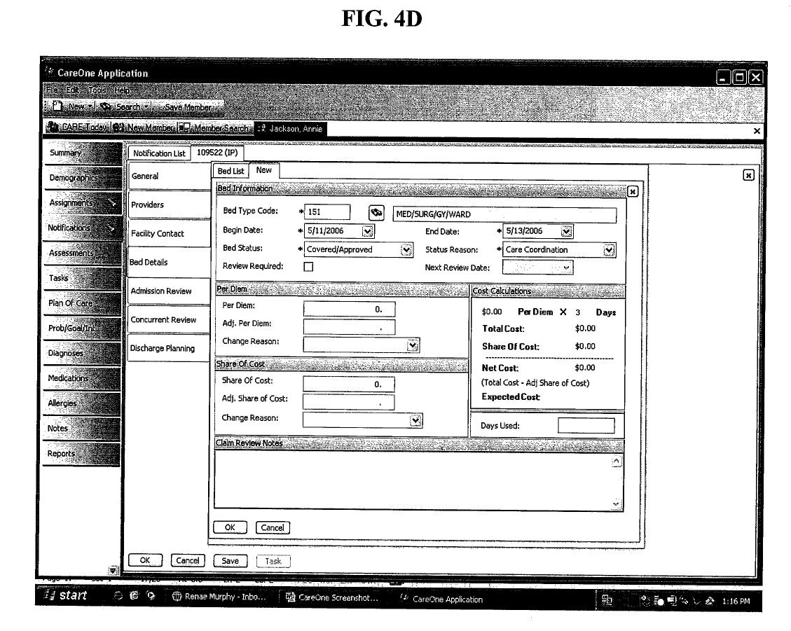

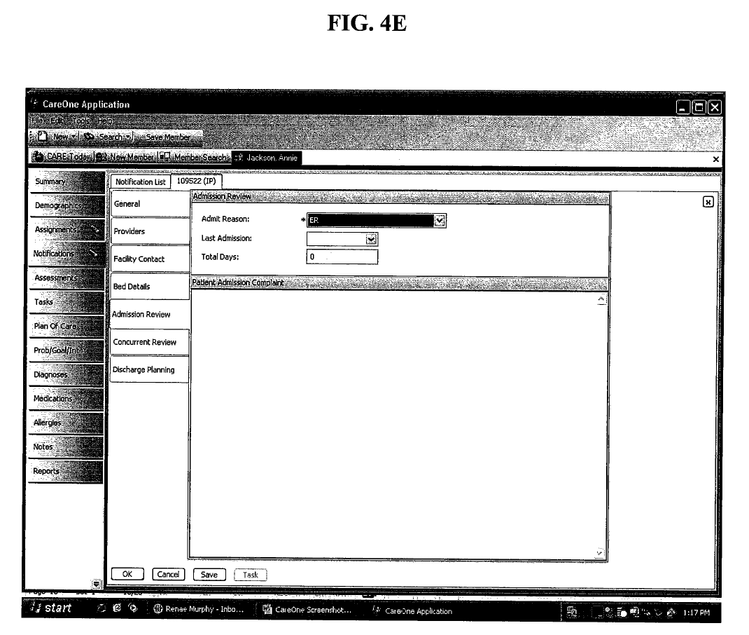

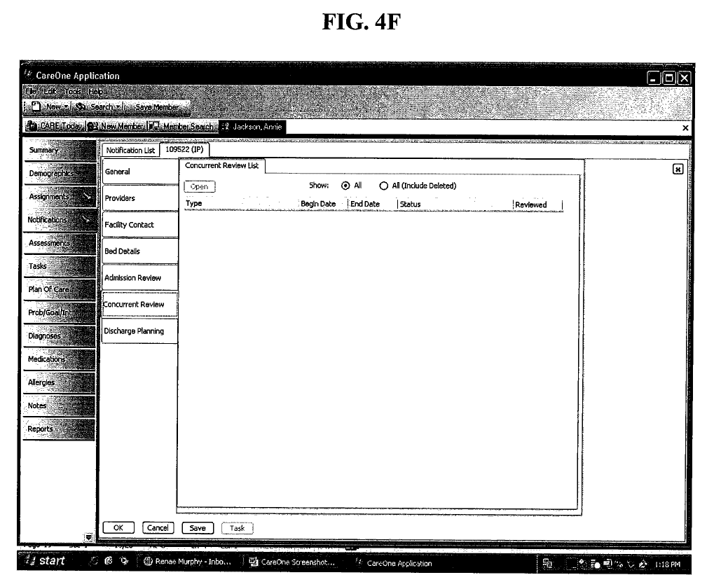

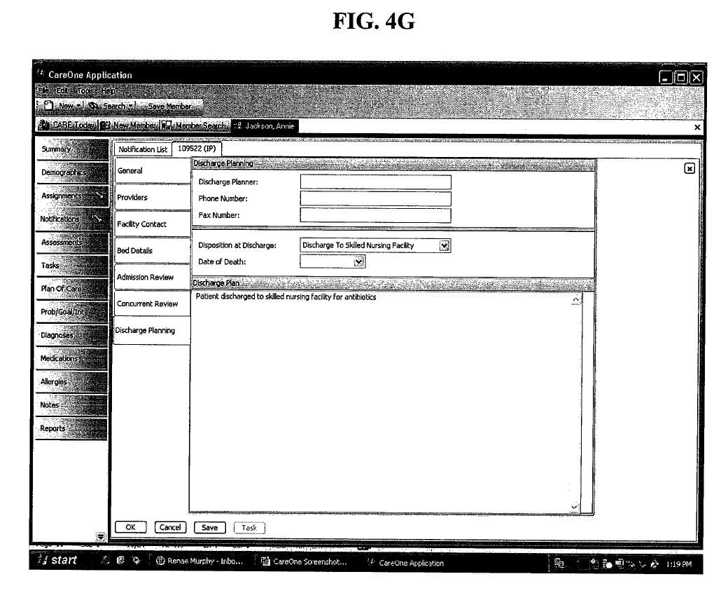

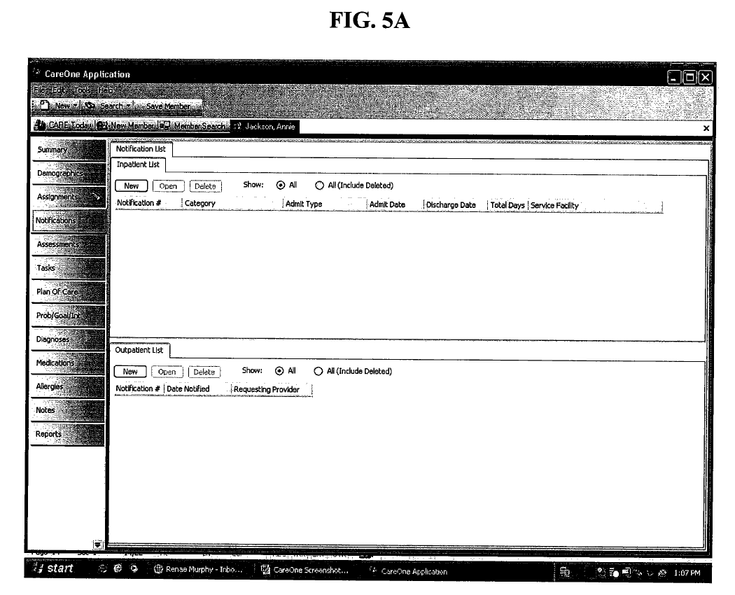

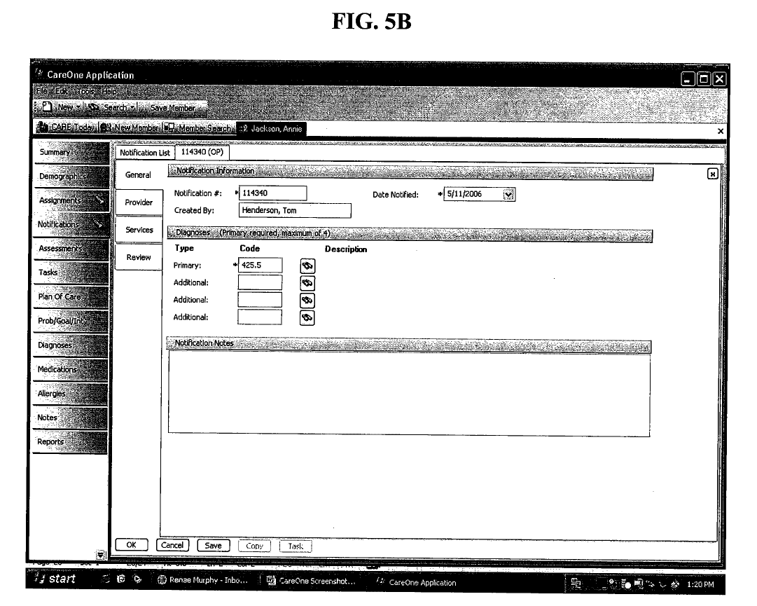

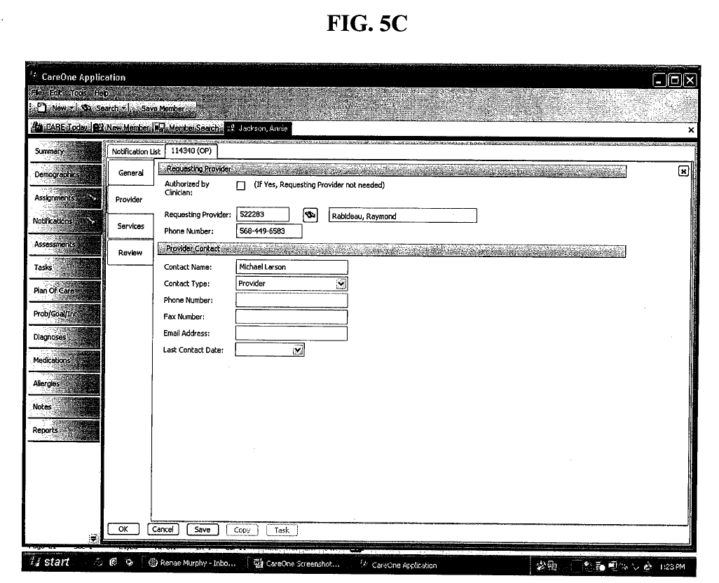

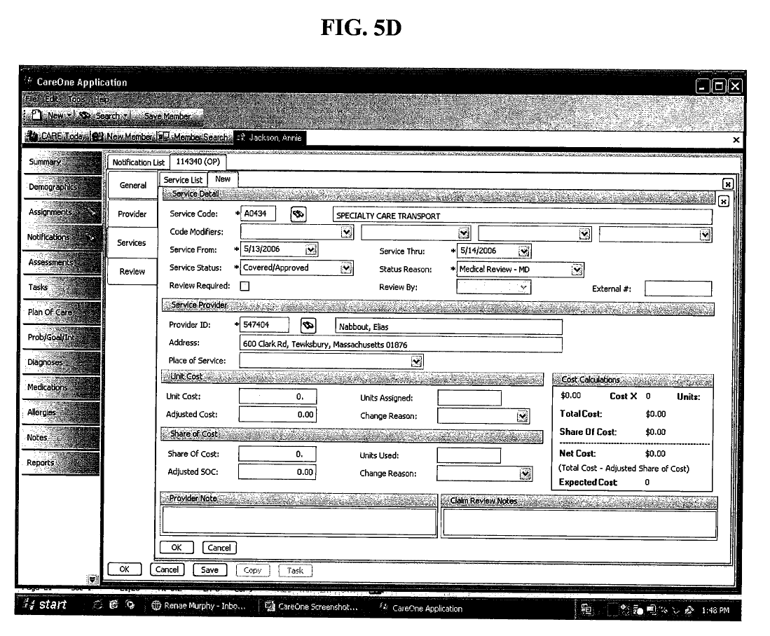

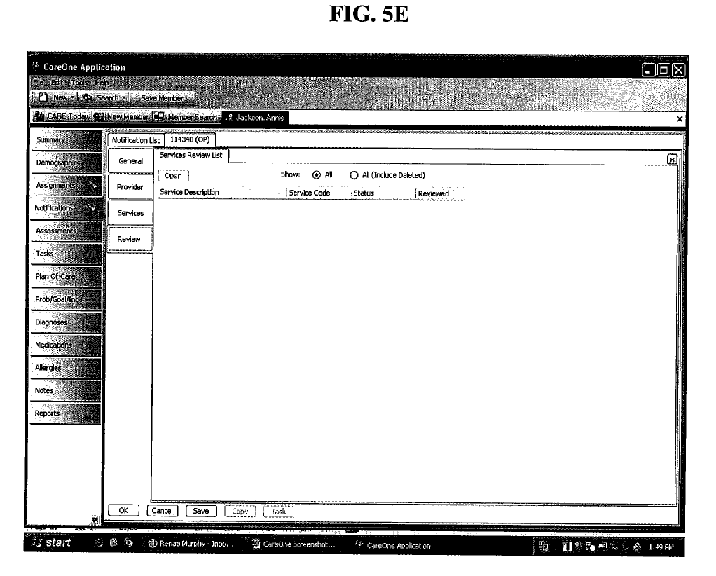

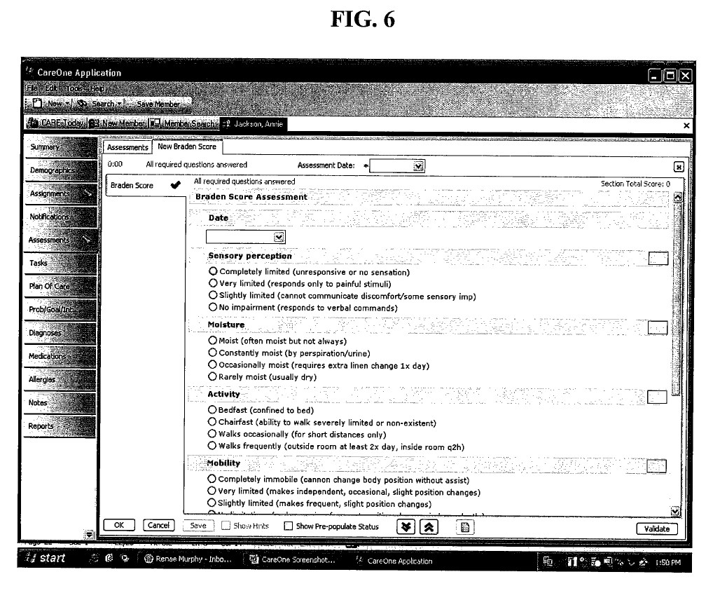

NOTIFICATIONS: The “Notifications” menu selection of FIG. 3 enables a user to create and update inpatient and outpatient notifications, which represent the process of determining whether the treatment or service selected for the member is covered by the member's insurance policy and the extent of any such coverage (e.g., full or partial coverage). An exemplary process for entering inpatient notifications relating to services provided at an inpatient facility is illustrated in FIGS. 4A-4G. An exemplary process for entering outpatient notifications for services and/or equipment provided outside an inpatient facility is illustrated in FIGS. 5A-5E.

Notification information for an inpatient service may require user entry of general information, providers information, facility contact information. bed details, admission review information, concurrent review information, and discharge planning (see vertical menu in FIG. 4A). As illustrated in FIG. 4A, each inpatient notification may require entry of general information (including notification date and identification number, one or more diagnoses, admission date and discharge date, and any notes desired by the user. As illustrated in FIG. 4B, provider information may identify the providers of the service, including the requested provider, the admitting provider, the attending provider, and the service facility. As illustrated in FIG. 4C, facility contact information may include contact name, type, phone number, fax number, email address, contact date, patient location and notes. With reference to FIG. 4D, bed details information may include bed type and bed status information (whether the bed type is covered by the member's insurance policy and to what extent or indicating that administrative review is needed to determine coverage) and associated costs (e.g., per diem cost and member's share of the costs). Status information and cost information may be entered manually by the user or provided automatically by the system 100 based upon the member data received from the member's health insurance company. Admission review information for inpatient services may describe the reason the member is receiving the service (see FIG. 4E). Concurrent review information for inpatient services (FIG. 4F) and discharge planning information for documenting the member's discharge after completion of the service (FIG. 4G) may also be entered for each inpatient notification.

With reference to FIG. 5A, a user may select to enter a new inpatient or outpatient notification. If the user selects to enter a new inpatient notification, the process illustrated by FIGS. 4A-4G above is followed. If the user selects to enter a new outpatient notification, the user enters “General” information, “Provider” information, “Services” information, and “Review” information (see vertical menu in FIG. 5B). FIG. 5B illustrates the display screen for the General information including one or more diagnosis codes to be entered by the user. The system 100 automatically provides the notification number, creator of the notification, and the date. Next, as illustrated in FIG. 5C, the user enters Provider information. Then, as illustrated in FIG. 5D, the user enters Services information concerning the outpatient service(s) to be provided. The user may use a search function to identify the appropriate service code(s). Code modifiers may be entered, such as an indication of the general health status of the member for whom the outpatient service is requested. The service dates are entered. “Service Status” (whether the service is covered by the member's insurance and, if so, whether the coverage is full or partial) data may be generated automatically by the system 100 based upon member data received from the member's health insurance company (policy coverage, service costs, etc.) as applied using defined coverage determination criteria, such as industry coverage standards promulgated by Milliman Care Guidelines® or other entities. The service status data alternatively may be entered manually by the user. If the user enters the data manually, the user is required to make an assessment of coverage based upon defined criteria, such as industry coverage standards promulgated by Milliman Care Guidelines® of other entities. If the user is not sure whether the service is covered by the member's health insurance policy, the user may select to “pend” the service status, indicating that further review by an administrator is required to determine coverage status. The user may also enter reasons for the service status (“Status Reason”). For example, a service may not be covered (Status=Not covered/not approved) because it is provided by a non-network provider or is covered by a third party health insurance policy (Status Reason=Third party coverage). Alternatively, the user may “pend” the service status and indicate in the “Status Reason” field that medical review is required to determine whether the service will be covered by the member's health insurance policy. Service provider information and location also may be entered by the user. Cost information, including the unit cost and the member's share of the cost may be populated automatically by the system based upon member data received from the member's insurance company. Provider notes and/or claim review notes may also be entered. As illustrated in FIG. 5E, the user may also enter Review information.

The system 100 may enable users to perform assessments by providing automated questionnaires that enable users to contact members and gather specific information about the member. The assessment data gathered may then be used to generate risk assessment data for the member. An exemplary assessment questionnaire display is shown in FIG. 6. As described above with reference to risk assessment application 103 in FIG. 1, the assessment data gathered from each member may be used, for example, to calculate a risk score for the member or to assign a level of care for the member, which is used to determine the appropriate care for the member.

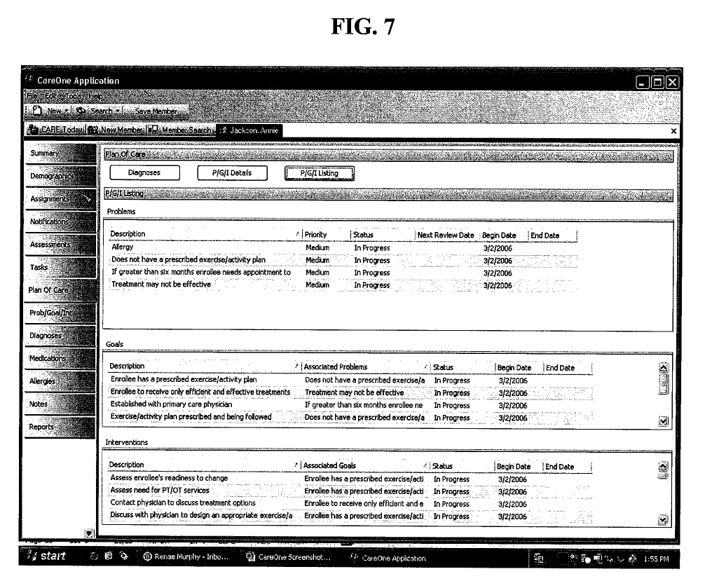

PLAN OF CARE: The plan of care for each member may comprise a summary of the members diagnoses, medications, allergies, problems, goals, and interventions to enable a user to obtain a quick overview of the member's health status. An exemplary plan of care for a selected member is illustrated in FIG. 7.

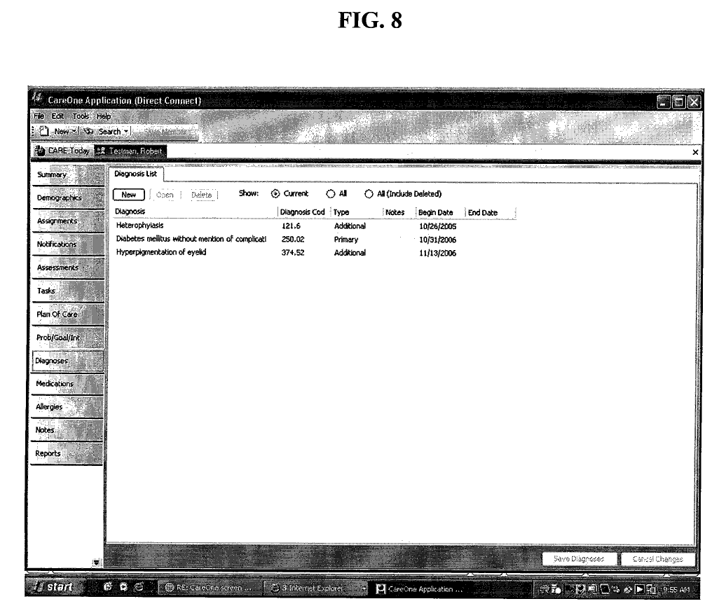

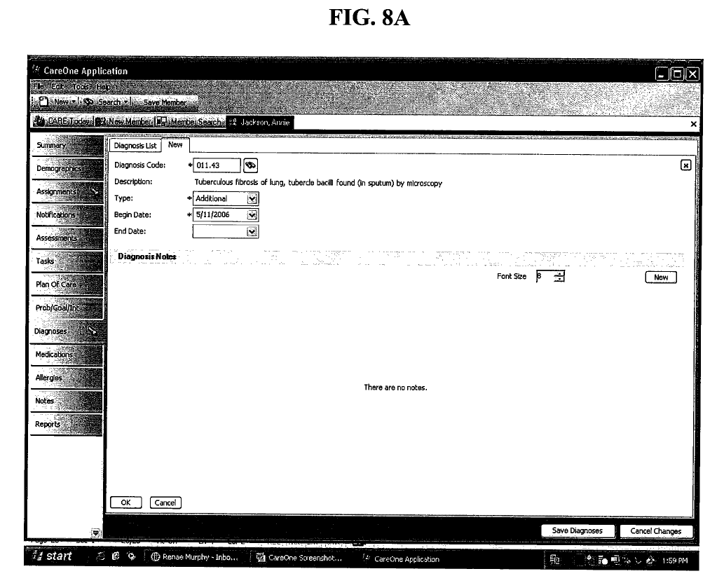

DIAGNOSES: The user may view a selected member's diagnoses using the display provided in FIG. 8. The display in FIG. 8 further enables the user to open and edit existing diagnoses, delete diagnoses, add new diagnoses, and enter notes, for example, using the entry screen illustrated in FIG. 8A. The user may employ search functionality to identify the desired diagnosis code when adding or modifying a diagnosis for the member. Diagnoses codes and descriptions may be received via data stream by managing application 101 of system 100, may be input manually, or may be provided by any other desired means to the system 100.

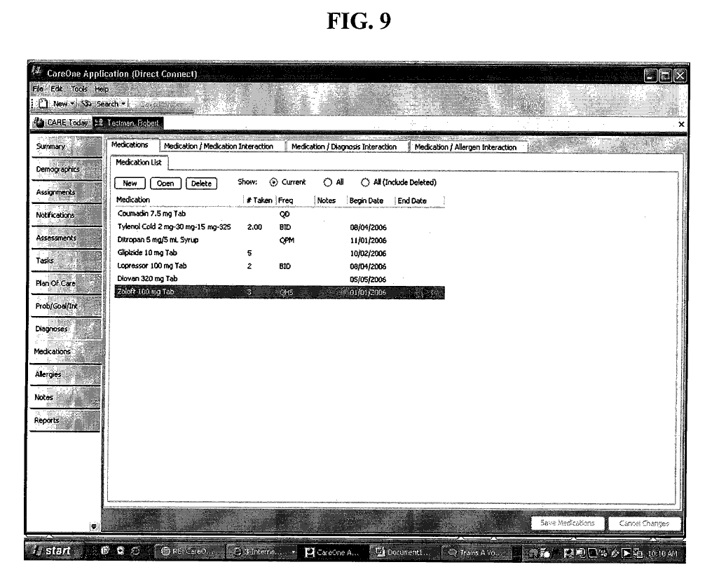

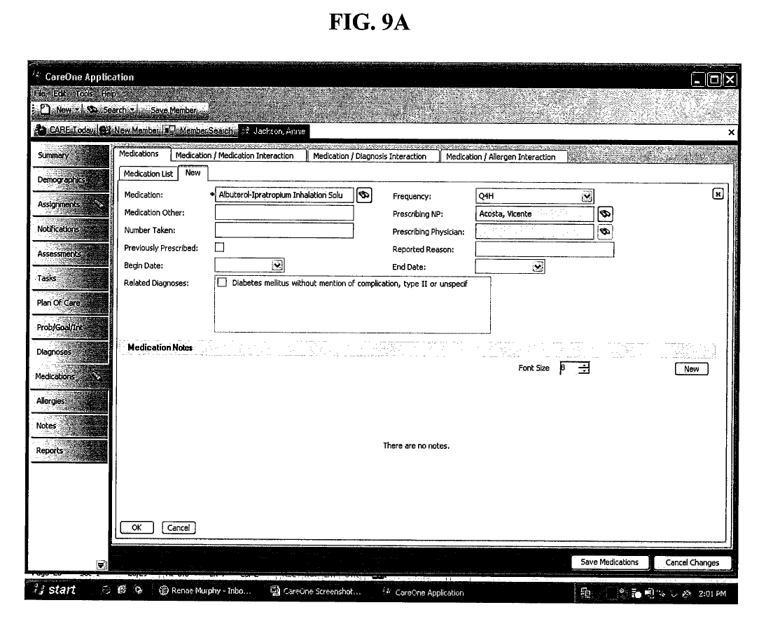

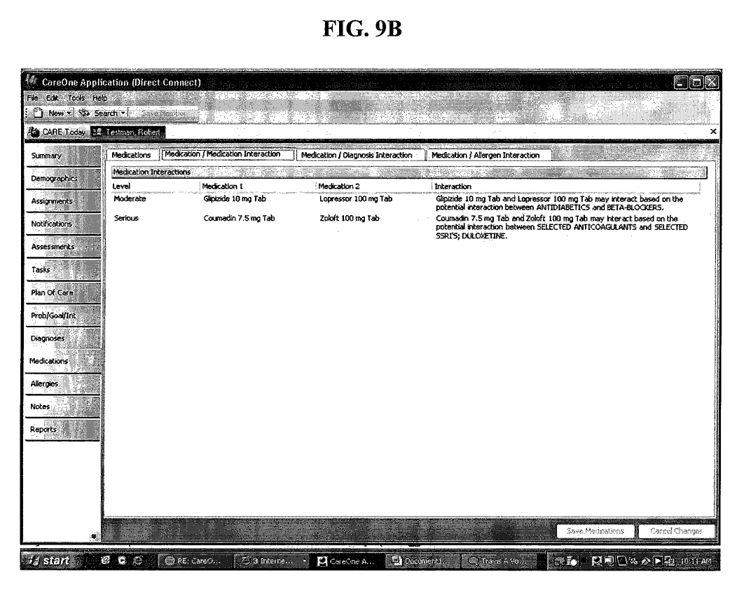

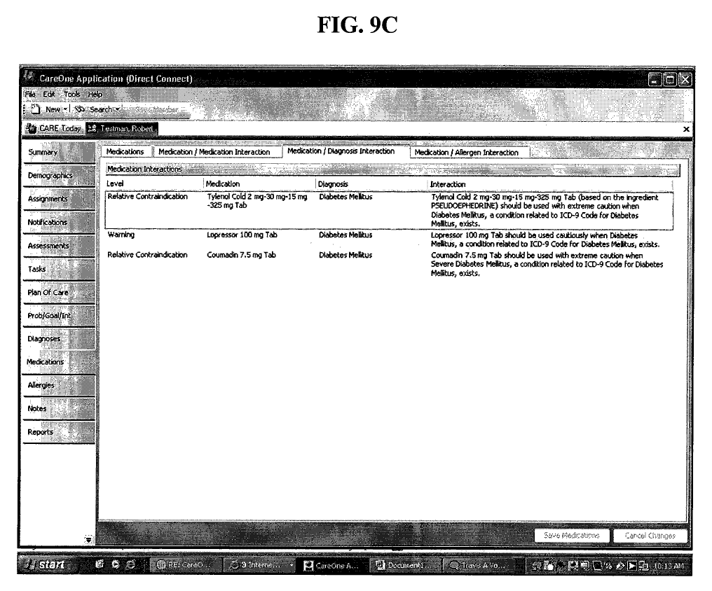

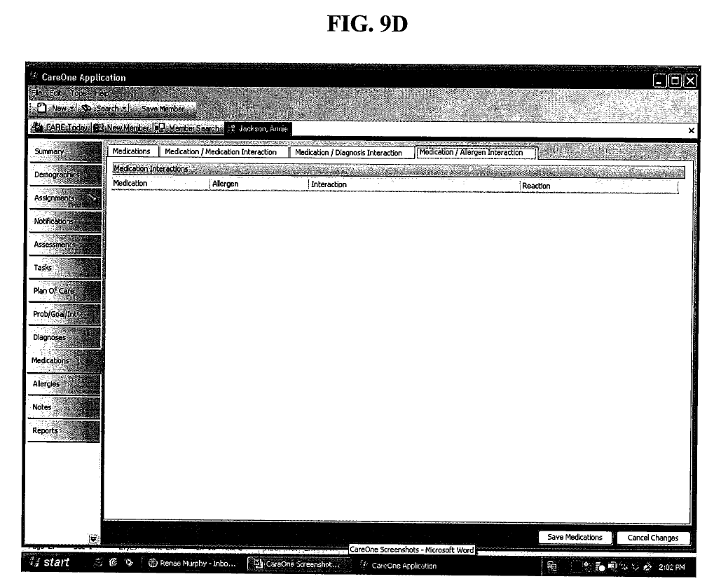

MEDICATIONS: The user may view a selected member's medications using the display provided in FIG. 9. The display in FIG. 9 further enables the user to open and edit existing medications, delete medications, add new medications, and enter notes, for example, using the entry screen illustrated in FIG. 9A. The user may employ search functionality to identify the desired medication code when adding or modifying a medication for the member. Medication codes and descriptions may be received via data stream by managing application 101 of system 100, may be input manually, or may be provided by any other desired means to the system 100.

FIG. 9B provides an exemplary customized display of medication-to-medication interactions that may be automatically generated by the managing application 101 of system 100 based upon data received from member safety knowledge database 102. This display is generated for each member based upon the medications entered into the system 100 for each member as well as the member safety knowledge data received from database 102.

FIG. 9C provides an exemplary customized display of medication-to-diagnosis interactions that may be automatically generated by the managing application 101 of system 100 based upon data received from member safety knowledge database 102. This display is generated for each member based upon the medications and diagnoses entered into the system 100 for each member as well as the member safety knowledge data received from database 102.

FIG. 9D provides an exemplary customized display of medication-to-allergen interactions that may be automatically generated by the managing application 101 of system 100 based upon data received from member safety knowledge database 102. This display is generated for each member based upon the medications and allergens entered into the system 100 for each member as well as the member safety knowledge data received from database 102.

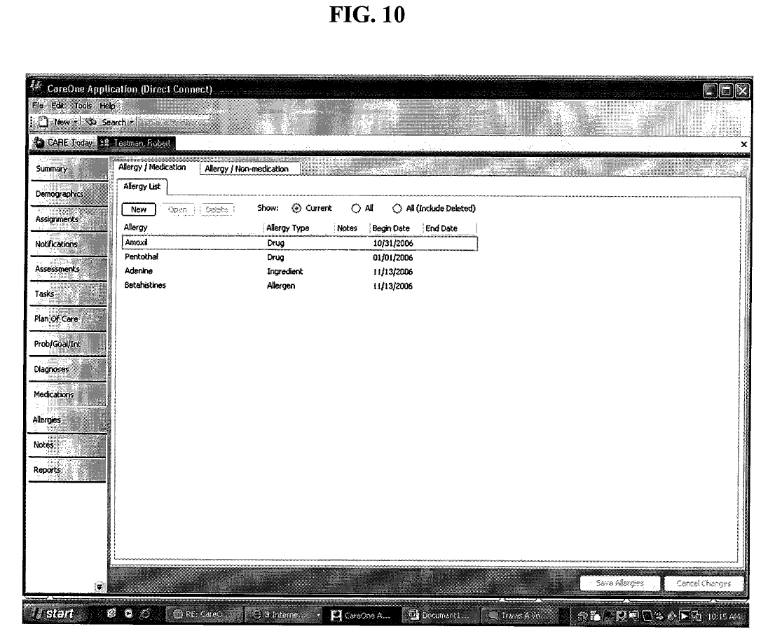

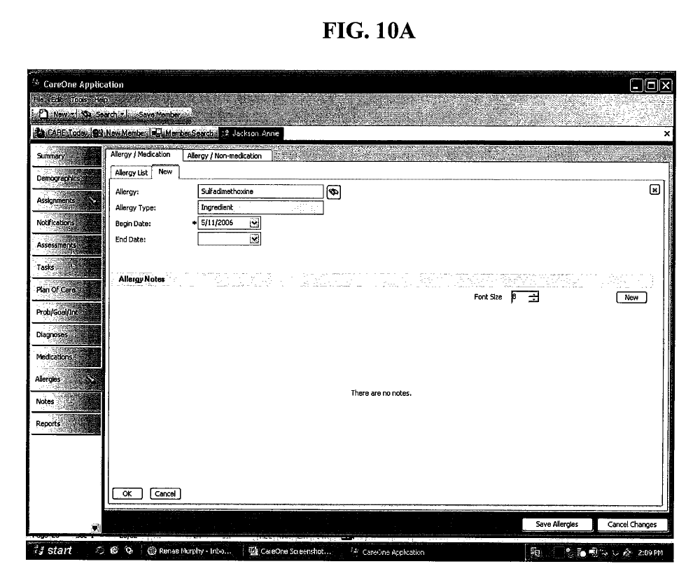

ALLERGIES: The user may view a selected member's allergies using the display provided in FIG. 10. The display in FIG. 10 further enables the user to open and edit existing allergies, delete allergies, add new allergies, and enter notes, for example, using the entry screen illustrated in FIG. 10A. The user may employ search functionality to identify the desired allergy code when adding or modifying a allergy for the member. Allergy codes and descriptions may be received via data stream by managing application 101 of system 100, may be input manually, or may be provided by any other desired means to the system 100.

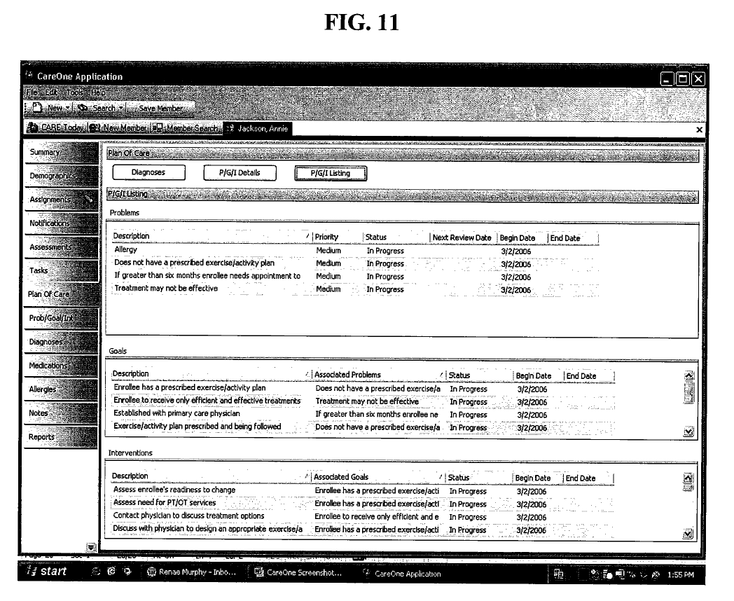

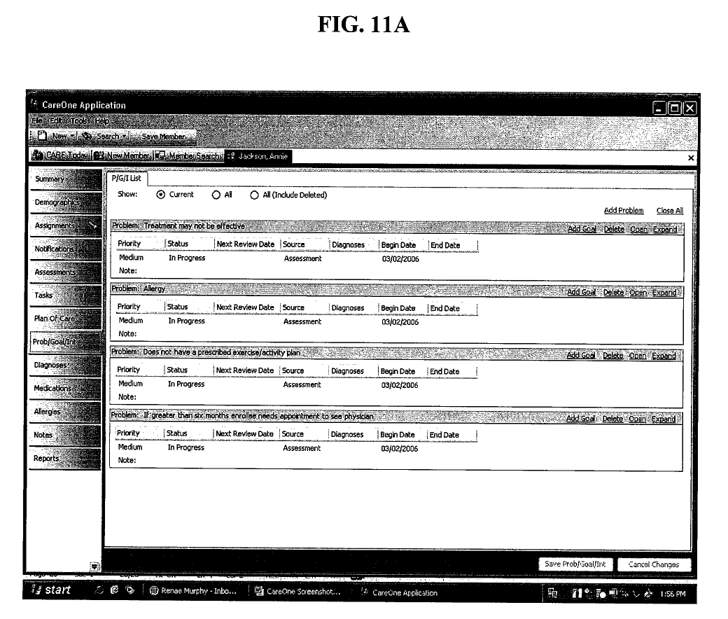

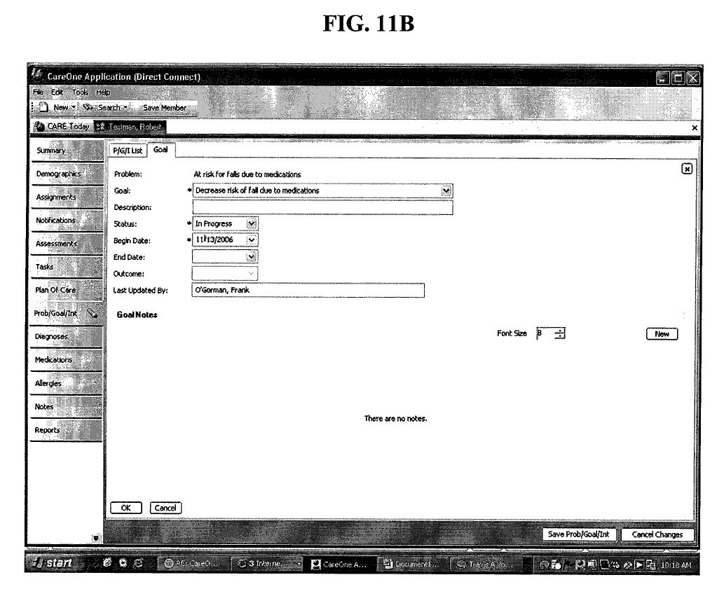

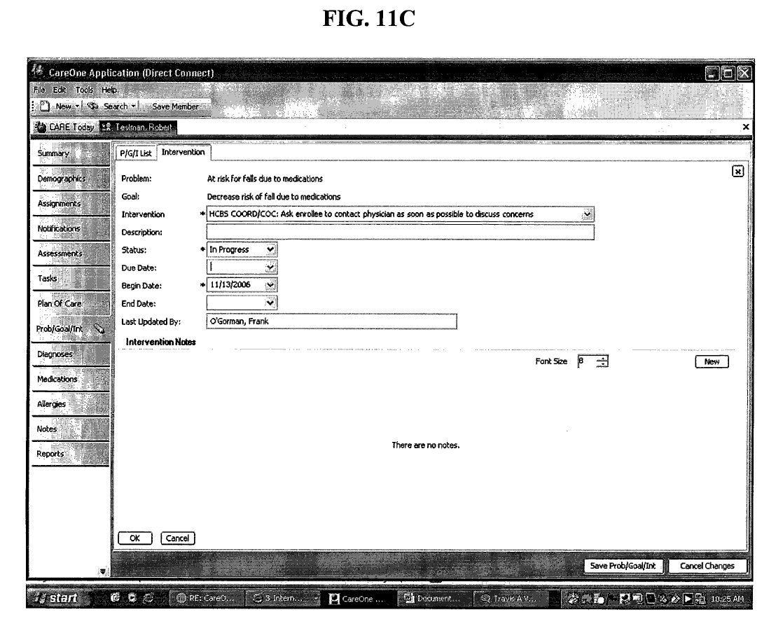

PROBLEMS/GOALS/INTERVENTIONS: The user may view a selected member's problems, goals, and interventions using the display provided in FIG. 11. The display in FIG. 11 further enables the user to create, delete and edit existing problems, goals, and interventions, as well as enter notes. A user may enter a new problem using a screen display such as that shown in FIG. 11A. For new and existing problems, the user may add new goals using a screen display such as that shown in FIG. 11B. For new and existing goals, the user may add new interventions using a screen display such as that shown in FIG. 11C. The user may employ search functionality to identify possible problems associated with the member's diagnoses, possible goals for the member's problems, and possible interventions for the member's goals. The user may select one or more possible problems, goals, and/or interventions for a member. If a new problem entered by the user for a member does not correspond to an existing member diagnosis, the user may be prompted to enter a new diagnosis for the member before entering the new problem. Problem, goal, and intervention descriptions and associated data may be received via data stream by managing application 101 of system 100, may be input manually, or may be provided by any other desired means to the system 100.

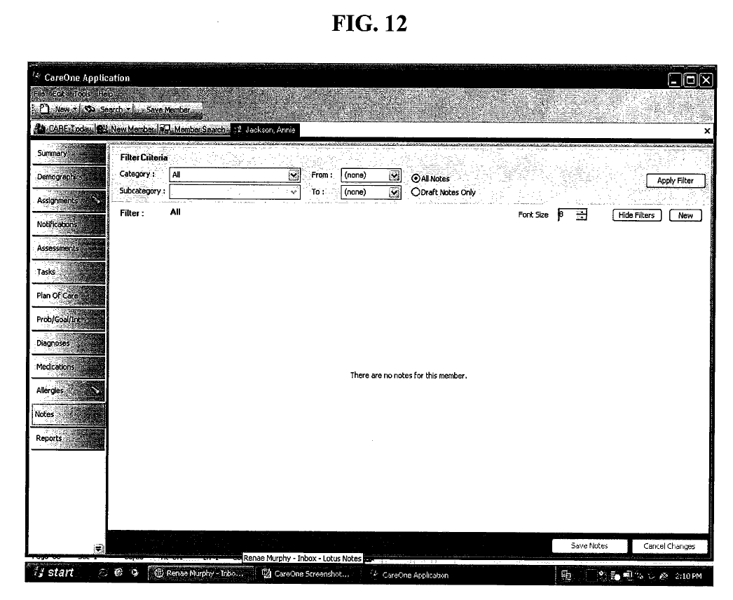

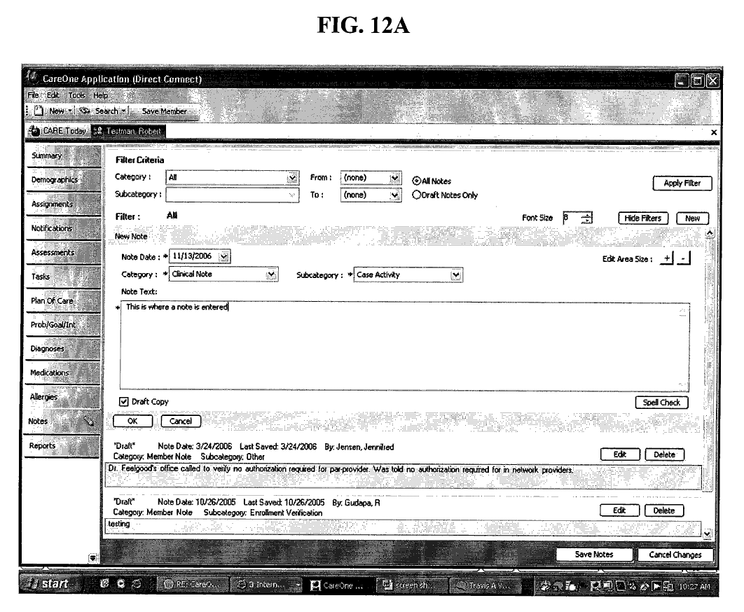

NOTES: The system 100 provides users with an opportunity to view and enter various types of notes concerning the members and aspects of the member's health and/or care into the system. For example, with reference to FIG. 12, notes already entered for a selected member are displayed. A user may enter new notes using an entry screen such as that illustrated in FIG. 12A. Users may have the option of leaving a note in draft form for subsequent editing. Once the user has finalized the note (the note is “complete”), the note is posted on the system 100 for access by other users.

REPORTS: The system 100 optionally may provide reporting functionality, for example, via reporting application 106, as desired by the users and implementers of the system. Reports may detail or summarize business aspects of members' health care, such as cost assessments, and/or may detail or summarize clinical aspects of members' health care, such as frequency of certain procedures, treatments, diagnoses, etc. Reports may be generated to remove any individual member information to protect the privacy of the members administered by the system 100. Reports may be generated and accessed directly by users of the system and/or made available via a reporting portal, such as one offered via a secure website on the Internet accessible with a web browser.

For example, FIG. 13 provides a listing of reports available to a user of the system. report details of a selected member listing report are shown in FIG. 13A.

FIGS. 14A-D provide views of an exemplary web display from a reporting portal that enables a user to select a report or letter that the user wishes to run. FIG. 14A illustrates an exemplary login screen. FIG. 14B illustrates an exemplary welcome screen with reporting information for the user. FIG. 14C provides an exemplary screen enabling the user to select one or more reports to run. The display provides the name of each available report, a description of the report, and other information about each report type. FIG. 14D provides an exemplary data entry screen enabling the user to define the parameters of a report to be run by the optional reporting application 106.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. An integrated electronic medical records and health care management system, comprising:
a managing application for receiving and storing member data associated with at least one member of a health plan, wherein the member data includes health insurance data and health assessment data for the member;
a risk assessment application coupled to the managing application for generating a level of care for the member based upon the member data received by the management application;
a member safety knowledge database for storing medication interaction data; and
a clinical protocols knowledge database for storing treatment data relating to the treatment of a plurality of health-related conditions,
wherein the managing application generates a plan of care for the member based upon the member data and member's level of care, the medication interaction data, and the treatment data, and
wherein the managing application monitors implementation of the member's plan of care and updates the plan of care based upon the implementation of the member's plan of care.

2. The system of claim 1, wherein the managing application further generates coverage data indicating whether costs associated with a health-related service selected for the member are covered by the member's health insurance policy.

3. The system of claim 1, further comprising a member monitoring application for providing member monitoring data to the managing application.

4. The system of claim 1, further comprising a reporting application for generating reports concerning healthcare management and implementation for members within a health plan.

5. The system of claim 1, further comprising a demand management application for providing 24-hour member access to medical personnel.

6. The system of claim 1, further comprising a member education application for providing member access to health-related educational information.

7. The system of claim 1, wherein the health insurance data includes health insurance claim data and data concerning the member's health insurance policy.

8. The system of claim 1, wherein the plan of care for the member may include one or more diagnoses, medications, allergies, medication-to-medication interactions, medication-to-diagnoses interactions, medication-to-allergen interactions, problems, goals, and interventions for the member.

9. The system of claim 1, further comprising a remote access server for enabling communication between the managing application and one or more remote terminals,
wherein, upon connection of the remote terminal to the remote access server, each remote terminal automatically receives from the managing application updated member data and member plans of care based upon an access level of a user of the remote terminal, and each remote terminal automatically transmits to the managing application updated data collected for any member.
